(19) United States
(12) Patent Application Publication
(10) Pub. No.: US 2005/0178037 A1
(43) Pub. Date: Aug. 18, 2005

(54) Hangtags for use with an automatic tag attacher/printer

(76) Inventor: Steven Kunreuther, New York, NY (US)

Correspondence Address: EPSTEIN DRANGEL BAZERMAN & JAMES LLP, Suite 820, 60 East 42nd Street, New York, NY, 10165, US

(21) Appl. No.: 10/775,228

(22) Filed: Feb. 11, 2004

(51) Int. Cl. G09F 3/10

(52) U.S. Cl. 40/674

(57) ABSTRACT

The hangtags with pre-punched openings are supplied on a roll with adjacent tags connected end-to-end by one or more elements which space the ends of the hangtags a short distance apart. Each hangtag in turn is aligned with an article to be tagged. A plastic fastener is received through the opening in the hangtag and the article, to attach the hangtag to the article. The connecting elements are severed simultaneously to separate the attached hangtag from the next hangtag by pulling the article from the apparatus such that a pull force is perpendicular to the hangtag end and is transferred through the fastener to the attached hangtag. The connecting elements are formed such that the pull force necessary to separate the hangtags is less than the force necessary to tear the portion of the hangtag body surrounding the fastener receiving opening. A reciprocating mechanism holds the next hangtag, as the attached hangtag is removed. It may also sever some or all of the connecting elements as it moves into position. A thermal transfer printer may be utilized to print blank hangtags as they are supplied to the fastener dispenser.

The present invention relates to hangtags and to devices for automatically attaching hangtags to articles and more particularly to a system for connecting hangtags end-to-end such that the hangtags can be separated from each other as tagged articles are removed from the tagging apparatus without using a cutter and to apparatus for automatically attaching such hangtags to articles that can be used in conjunction with a conventional thermal transfer printer.

Hangtags are utilized to label large quantities of many different types of products, from soft goods, such as clothing, to food products, including vegetables and corn. One popular means of attaching hangtags to articles is by using plastic fasteners. Such fasteners are provided with a T-bar at one end. The T-bar is connected to an enlarged paddle, located at the other end of the fastener, by a thin, flexible filament. The filament is stretched during the fabrication process to give it a high tensile strength.

To attach the fastener, an attaching device with a housing having a protruding hollow metal needle is utilized. The needle is inserted through a pre-punched opening in the hangtag and penetrates the article to be tagged. The T-bar end of the fastener is then ejected through the needle such that the T-bar end is situated on one side of the hangtag and article, with the enlarged paddle end on the other, attaching the hangtag to the article.

Hand held devices for attaching fasteners of this type are used widely and commercially available from a number of suppliers. Those devices may be manually operated or power driven, either electrically or pneumatically. Table mounted versions of the attaching devices are also commonly utilized, sometimes in conjunction with automatic tag feeding mechanisms. Circuitry for controlling the tag feed and fastener dispensing operations is provided. See, for example, U.S. Pat. No. 3,896,713 entitled “Top-Feeding Automatic Tag-Attaching Machine” issued to Mato on Jul. 29, 1975 and U.S. Pat. No. 4,235,161 entitled “Automatic Tag Attaching Apparatus' issued to Kunreuther on Nov. 25, 1980.

Some automatic tagging mechanisms available currently are capable of feeding end-to-end connected preprinted hangtags from a supply roll. However, those machines require an automatic cutter or knife to cut the hangtags before the tagged article can be removed from the machine.

Although using a knife or cutter with sharp blades results in a clean, straight cut, the blades must be continually sharpened. Further, the mechanism is complicated and may be hazardous to the operator.

Other automatic tagging machines utilize automatic tag feed mechanisms which transfer already separated preprinted tags, one at a time, from a stack to the fastener attacher. Some of those tag feed mechanisms, such as the one disclosed in U.S. Pat. No. 4,235,161 noted above, use a reciprocating slide to move each tag from the stack to a position aligned with the attacher needle. The attacher is then advanced to insert the needle through the tag opening. Other mechanisms utilize a vacuum arm to pick up the hangtag from the stack. The arm is moved through a nonlinear path to place the hangtag over the stationary needle of an adjacent fastener dispenser. See U.S. Pat. No. 4,781,318 entitled “Tagging Apparatus” issued to R. Meyers on Nov. 1, 1988.

The automatic tag feed mechanisms was [symbol] suspense separate tags supplied in a stack require precise positioning of the tag stack hopper because the pre-punched tag opening, which is relatively small, must align with the attacher needle. Because of this, considerable set up time is required and machine downtime cannot be avoided when changing hangtag sizes.

In the vacuum-type apparatus, vacuum as well as electrical power are required to operate the apparatus. In a hostile environment, tag feeders of the vacuum-type do not always operate reliably.

Only previously printed tags can be utilized in systems without cutters. Since those systems feed hangtags from a stack, it is not possible to employ a conventional thermal transfer printer, designed to print tags as needed, in conjunction with such automatic attaching systems.

The present invention eliminates the necessity of using an automatic cutter in a system where the hangtags are connected end-to-end and supplied on a roll. It overcomes the positioning problems related to feeding tags from a stack. Further, the need for vacuum creating equipment is avoided. This is accomplished through the use of hangtags connected together in a novel way. The automatic tagging apparatus utilizes hangtags supplied on a continuous roll, instead of in a stack, without requiring a cutting mechanism. No vacuum or slide tag transfer mechanisms are required.

The hangtags are removed from the supply roll in a continuous strip. The lead hangtag is guided into alignment with the attacher needle and attached to the article by the fastener. The next tag in sequence is either held while the attached hangtag is separated by simply pulling the tagged article away from the apparatus and/or some of the connecting elements between the attached hangtag and the held hangtag are automatically severed, prior to removal of the attached hangtag, making removal of the attached hangtag easier. This hangtag connection system also permits the hangtags to be used with a conventional thermal transfer printer that prints blank tags as required, without a cutter, with or without the automatic attaching device.

Hangtags are typically made of paper or a paper product and may be coated on one or both sides. The hangtags are commonly formed and supplied in sheets. In some instances, the sheets are cut with large industrial cutters to obtain the individual tags. This can pose a problem because the tags must be cut in an operation separate from tagging. A clean, controlled environment is required in which to cut the hangtags. However, such an environment is not always available in places where automatic tag attaching apparatus is employed.

In other instances, hangtags are connected together end-to-end and/or side-to-side on rolls by a series of spaced connecting portions, defined by a line of perforations. The perforations define the tags. Hangtags supplied in this way can be used in automatic tag feed apparatus without automatic cutters only after they are first manually separated and assembled into a stack. To do this, the tags must first be printed. The printed tags then are rewound on a roll. Later, they are cut and stacked.

In order to manually separate the printed hangtags one from the other without a cutter, a force directed at an acute angle to a line perpendicular to the perforations is applied to the connecting portions between the perforations, such that the connecting portions be torn sequentially, beginning at one side of the hangtag and progressing across the end of the hangtags until the opposite side is reached. To accomplish this, one hand must hold one of the hangtags while the adjacent hangtag is grasped by the other hand and pulled in a direction which is at an acute angle to a line perpendicular to the perforation line to sequentially tear the connecting portions, one at a time, until all of the connecting portions are severed. This tends to leave somewhat jagged edges on the separated hangtags.

The structure of the perforated connection is purposefully designed to have a high strength in the direction perpendicular to the ends of the hangtags. It is quite difficult to pull the hangtags apart by a force which is directed perpendicular to the ends of the hangtags. It is this feature which makes rolled hangtags connected in the conventional manner unsuitable for use with automated tagging apparatus without a cutter.

The present invention overcomes this disadvantage by utilizing an entirely different system for connecting the hangtags in which one or more connecting elements are interposed between adjacent hangtags, spacing the hangtags a short distance apart. The connecting elements are formed so that they can be severed simultaneously by a pull force transferred through the anchored fastener, which force is directed perpendicular to the hangtag ends. By making the portion of the hangtag surrounding the pre-punched fastener receiving opening stronger than the force necessary to simultaneously sever the connecting elements, the hangtag attached to the article by the fastener can be separated from the next hangtag by simply removing the article from the tag attaching apparatus by pulling in a direction perpendicular to the hangtag end. This permits the entire attaching processes to be fully automated by utilizing hangtags supplied on a continuous roll, without the necessity of an automatic knife or cutter. Further, this is accomplished in a way which leaves a straight, even edge, unlike that which results from the separation of perforated sheets.

In some instances, it may be preferrable to sever some or all of the connecting elements between the attached hangtag and the next hangtag in sequence to make removal of the attached hangtag even easier. This can be done with or without holding the next hangtag in sequence, depending upon the strength and number of the connecting elements employed.

It is, therefore, a prime object of the present invention to provide hangtags for use in automatic attaching apparatus which can be supplied on a continuous roll and do not require a cutting to separate the hangtags.

It is another object of the present invention to provide hangtags on a continuous roll in which the hangtags are connected end-to-end by one or more elements which space the tags a short distance apart, the connecting elements being simultaneously severable to separate the hangtags by the application of a pull force through the anchored fastener, in a direction generally perpendicular to the hangtag end.

It is another object of the present invention to provide hangtags for use in an automatic attaching apparatus where the hangtags are severable by application of a force through the anchored fastener, which force is less than the force necessary to tear the portion of the hangtag adjacent the fastener receiving opening.

It is another object of the present invention to provide hangtags for use in an automatic attaching apparatus in which the pre-punched openings serve as a sprocket hole as well to receive the plastic fastener.

It is another object of the present invention to provide hangtags for use in an automatic attaching apparatus in which the hangtag openings and sprockets are noncircular to prevent rotation of the tag.

It is another object of the present invention to provide an automatic tag attacher with a reciprocating mechanism which holds the next tag in sequence, facilitating separation of the attached tag by simply pulling the article.

It is another object of the present invention to provide an automatic tag attacher wherein the reciprocating mechanism severs some or all of the connecting elements so as to further reduce or eliminate the pull force necessary to separate the hangtags.

It is another object of the present invention to provide an automatic tag attacher which does not require vacuum to feed tags or precise tag stack positioning.

It is another object of the present invention to provide an automatic tag attacher in which the necessity of utilizing an automatic knife or cutter mechanism to separate the hangtags is eliminated but the resulting separated hangtag ends are straight and clean.

It is still another object of the present invention to provide hangtags which can be used in conjunction with a thermal transfer printer capable of printing labels as required, without the necessity of a cutter.

In accordance with the present invention, hangtags are supplied on a roll of end-to-end connected hangtags. Adjacent hangtags are connected together by one or more connecting elements extending between the ends of adjacent hangtags. The connecting elements space the hangtag ends a short distance apart. The connecting elements are severable to separate adjacent hangtags by the application of a force in a direction substantially perpendicular to the ends of the hangtags.

The connecting means preferably includes two or more spaced connecting elements. The connecting elements are simultaneously severed when the force is applied.

The hangtags include a body with an opening adapted to receive a fastener. The opening is defined by a body portion adjacent the opening. The connecting elements are severable to separate adjacent hangtags by the application of a force which is less than the force necessary to tear the portion of the tag body adjacent the fastener receiving opening.

The hangtags are adapted for use with automatic tag attaching apparatus. Reciprocating means are provided in the automatic tag attaching apparatus for holding one hangtag as the adjacent hangtag is separated from the held hangtag by severing the connecting elements. The reciprocating means may also sever some or all of the connecting elements to further reduce or eliminate the pull force necessary to separate the hangtags.

The hangtags may be used in combination with means for feeding connected hangtags supplied on a roll, one at a time, into alignment with means for dispensing a fastener. The fastener dispensing means includes a hollow needle, means for inserting the needle into the hangtag opening and means for ejecting a fastener through the needle. The hangtag feeding means includes a wheel which has a plurality of sprockets of substantially the same size and shape as the hangtag opening. The hangtag opening can serve both as a sprocket hole and to receive the fastener. The hangtags preferably have substantially straight sides and rounded corners.

The hangtags may be used with thermal transfer means for imprinting the hangtag. The thermal transfer means may also be used to feed the printed hangtags to a means for attaching the printed hangtags to an article.

Preferably, two or more connecting elements are utilized. For some applications, the opening in the hangtag and the sprocket both can be made non-circular so as to prevent rotation of the hangtags relative to each other.

The hangtag body preferably has first and second corners. The connecting element is located approximately equidistant between the corners.

To these and to such other objects which may hereinafter appear, the present invention relates to hangtags for use with an automatic tag attacher/printer, as described in detail in the following specification and recited in the annexed claims, taken together with the accompanying drawings, wherein like numerals refer to like parts and in which:

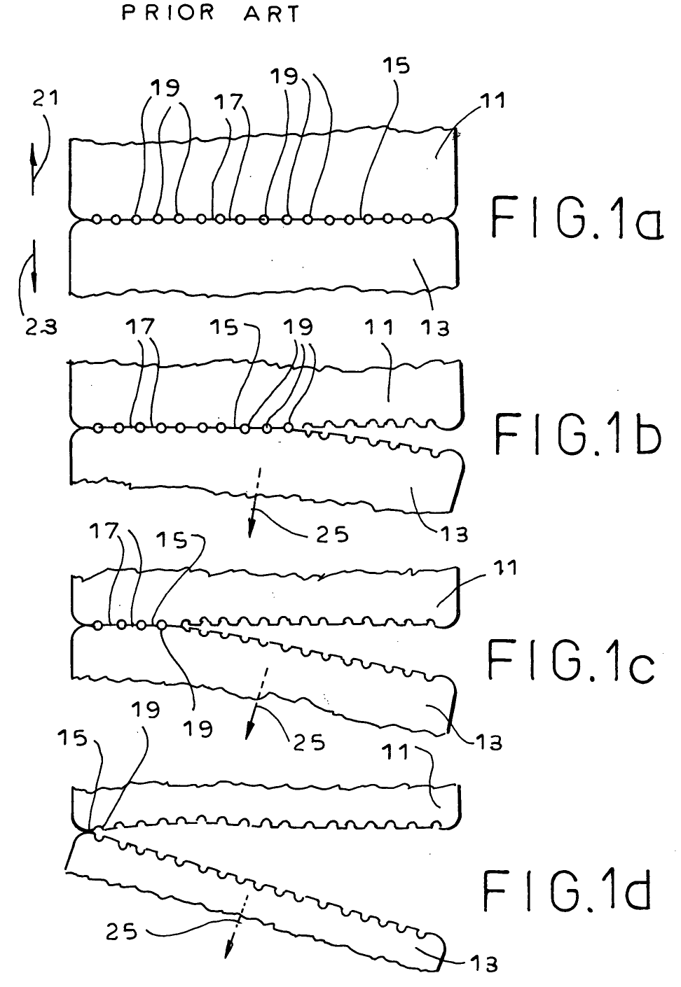

FIGS. 1a-1d are sequential schematic elevational views illustrating how conventional perforated tags are separated.

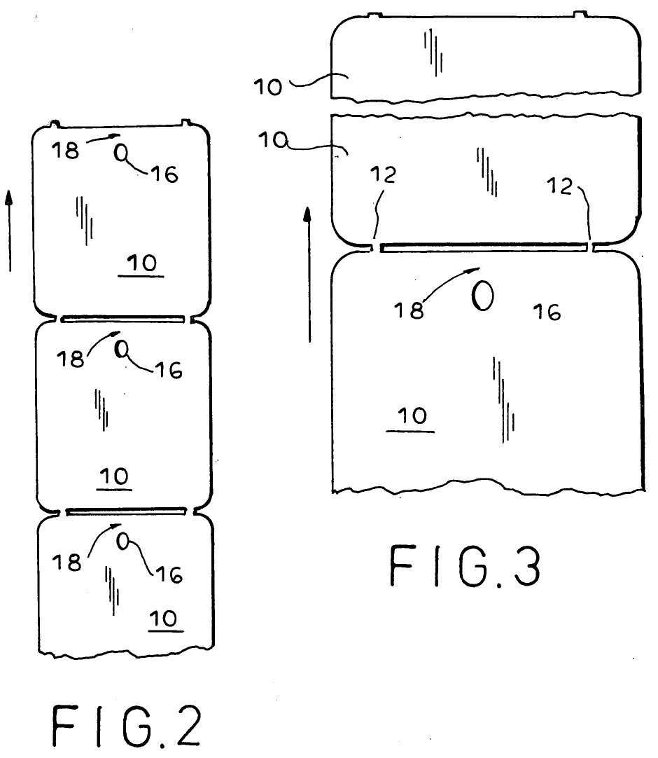

FIG. 2 is an elevational view of a portion of a strip of connected hangtags of the present invention;

FIG. 3 is an enlarged view of two adjacent hangtags shown in FIG. 2, illustrating the manner in which the hangtags are connected;

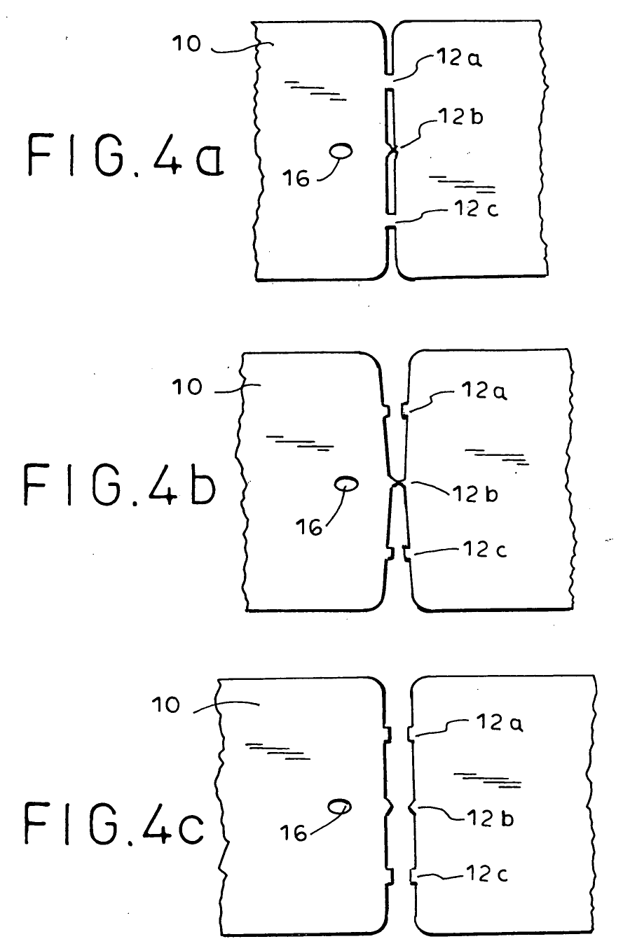

FIGS. 4a-4c are sequential schematic elevational views illustrating the sequence of hangtag separation when a reciprocating member is employed to sever some of the connecting elements.

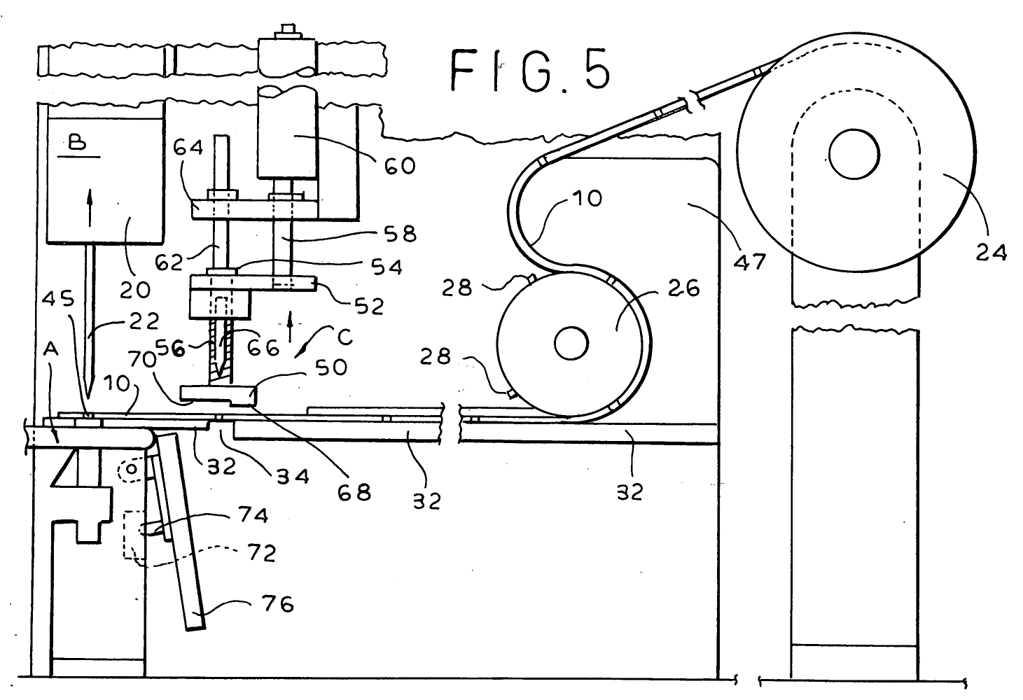

FIG. 5 is a schematic side view of the automatic tag attacher of the present invention, showing a first preferred embodiment of the reciprocating member in the initial position;

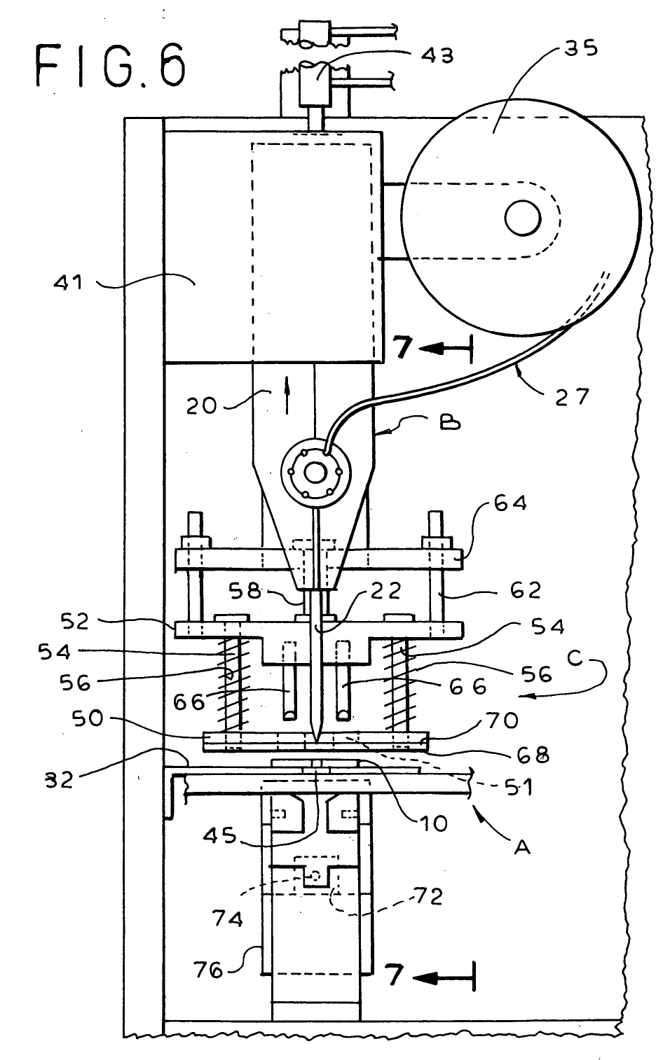

FIG. 6 is a front elevational view of a portion of the tag attacher of FIG. 5;

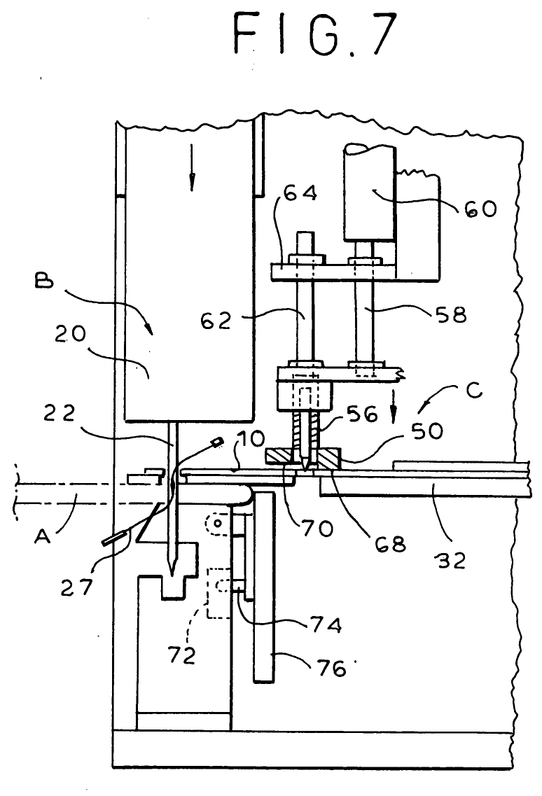

FIG. 7 is a schematic side view of the apparatus taken along line 7-7 of FIG. 6, showing the reciprocating member in its final position.

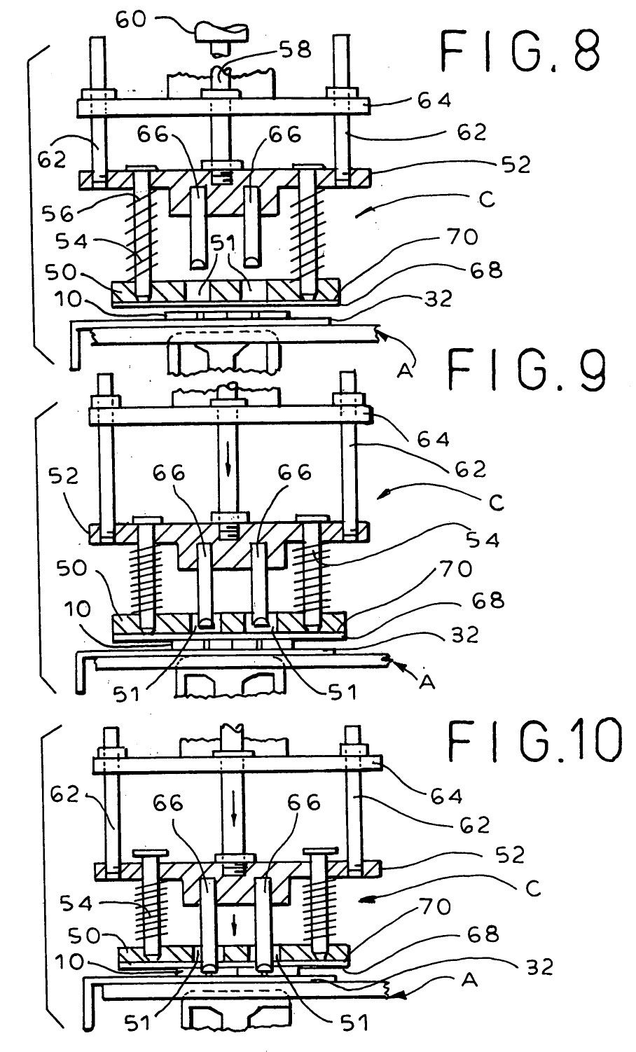

FIG. 8 is a front elevational view of the reciprocating member of FIG. 5 in its initial position.

FIG. 9 is a front elevational view similar to that of FIG. 8, showing the reciprocating member in its intermediate position;

FIG. 10 is a front elevational view similar to that of FIG. 8, showing the reciprocating member in its final position;

FIG. 11 is a front elevational view of a second preferred embodiment of the reciprocating member, shown in its initial position;

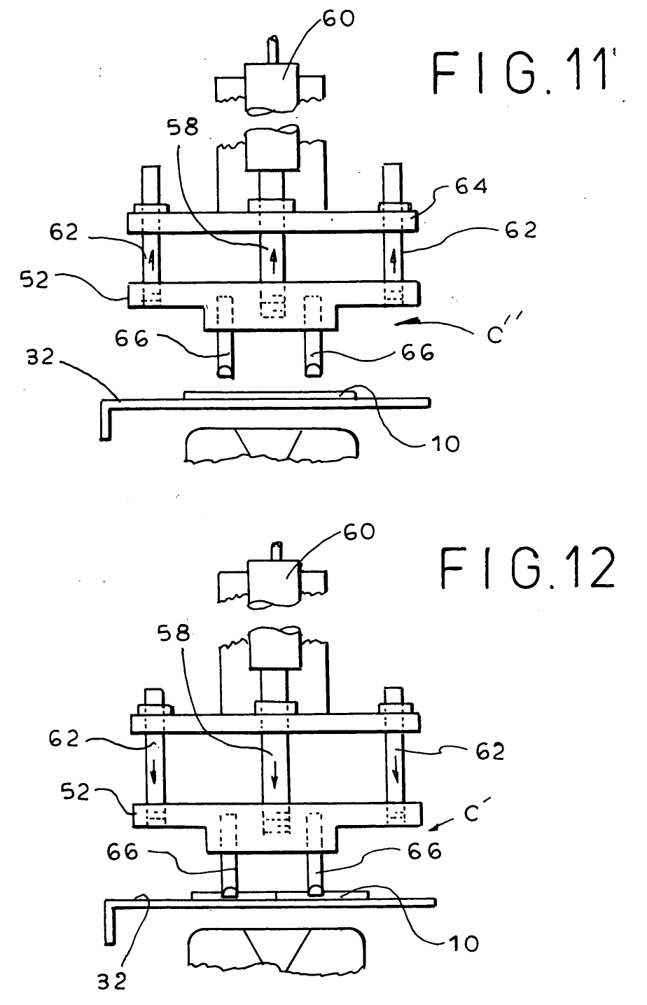

FIG. 12 is a front elevational view similar to that of FIG. 11, showing the reciprocating member, in its final position;

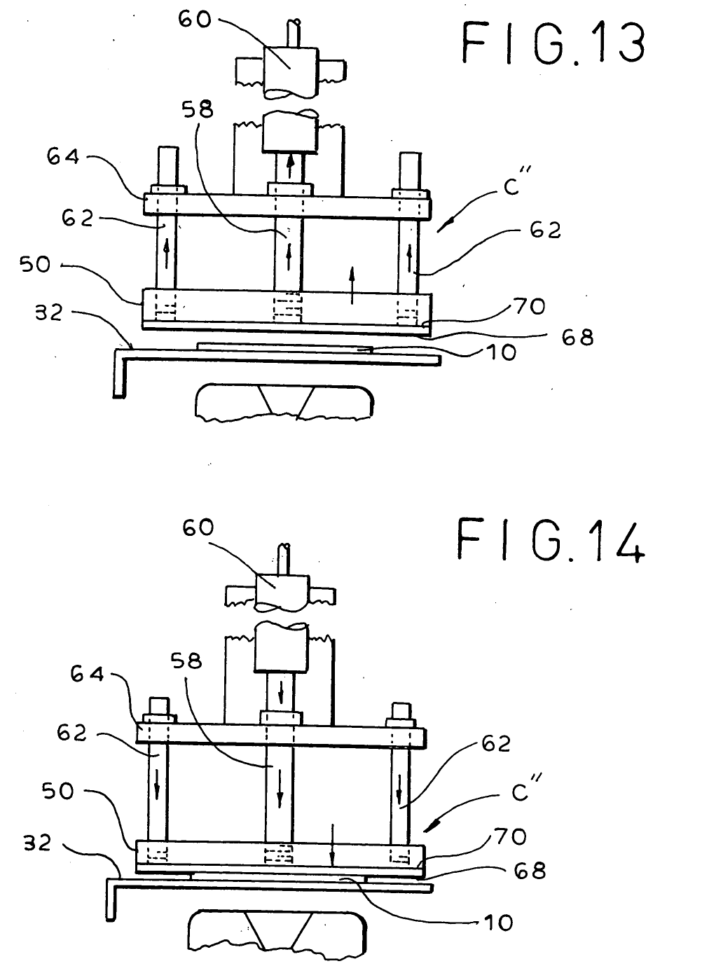

FIG. 13 is a front elevational view of a third preferred embodiment of the reciprocating member, shown in its initial position;

FIG. 14 is a view similar to FIG. 13, showing the reciprocating member in its final position;

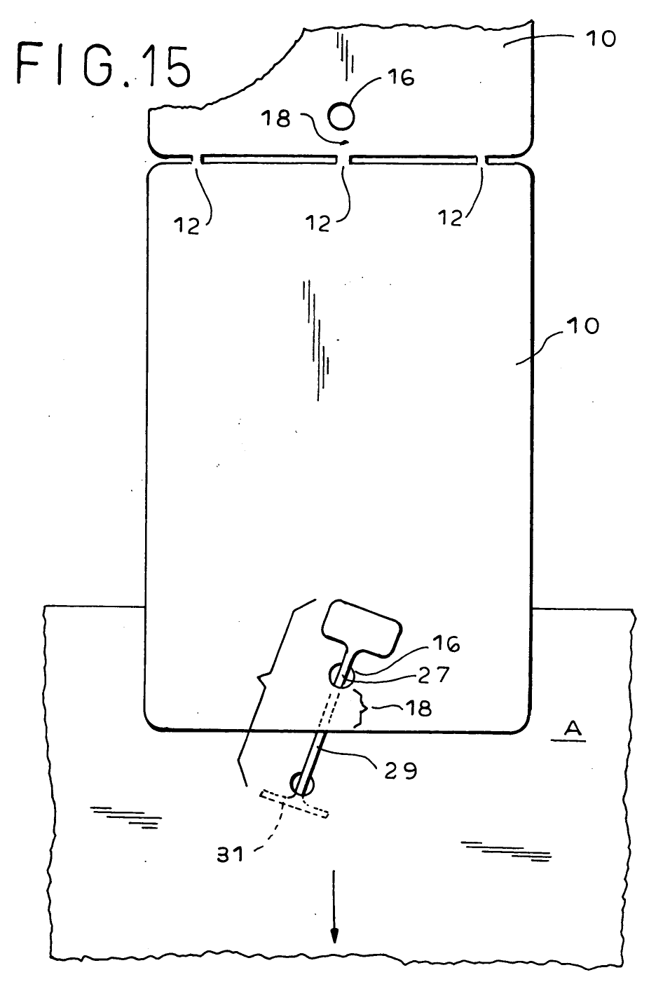

FIG. 15 is a top elevational view of a hangtag of the present invention as it appears attached to an article by a fastener, prior to separation of the attached hangtag from the next tag in sequence;

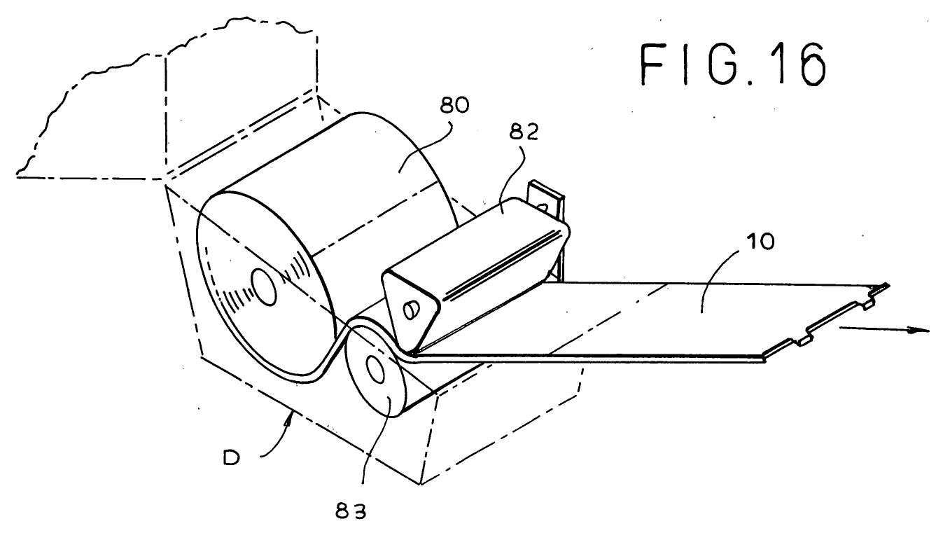

FIG. 16 is an isometric view of a tag printer utilizing the hangtags of the present invention; and

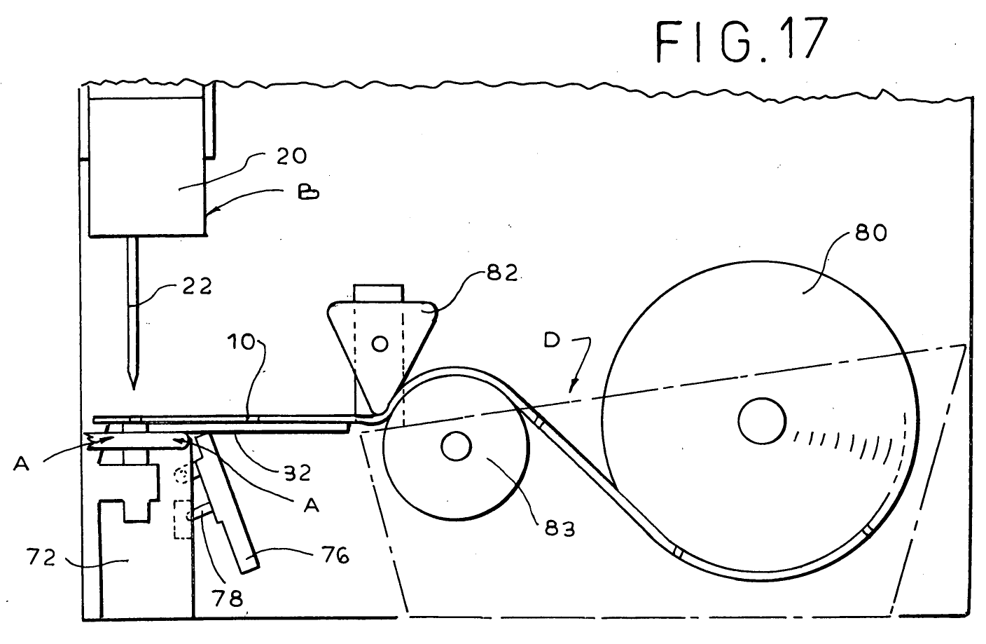

FIG. 17 is a side elevational view of a tag printer and automatic tag attacher combination.

FIGS. 1a through 1d show in a sequential manner the way in which conventional end-to-end connected hangtags are separated. As shown in FIG. 1a, adjacent hangtags 11 and 13 are joined along line 15 which consists of a plurality of connected portions 17 defined by spaced perforations 19. Arrows 21, 23 depict forces which are applied in a direction substantially perpendicular to line 15. When forces are applied in the direction perpendicular to line 15, it is virtually impossible to pull tags 11 and 13 apart.

Tags 11 and 13 are constructed to be separated by tearing the connecting portions 17, in sequence, starting from one side, as shown in FIG. 1b, and continuing across line 15 (FIG. 1c) until the opposite side is reached (FIG. 1d). This is accomplished by applying force at an acute angle relative to the line perpendicular to line 15, such as shown by arrow 25 which makes an increasing angle with the line perpendicular to line 15, as more and more of the connecting portions are tom.

By way of contrast, the hangtags 10 of the present invention have no connecting portions. They are spaced a short distance apart by connecting elements 12 which are designed to sever simultaneously when a force in a direction generally perpendicular to the end of the hangtag is applied to the hangtag through a plastic fastener.

As seen in FIGS. 2, 3 and 4a-4c, the hangtags 10 of the present invention are generally rectangular in shape, with straight sides and rounded corners. Tags 10 are made of a paper product, suitable for being imprinted with information regarding the product to which they will be attached, such as the size, material, color and the like, as well as care instructions.

Hangtags 10 are connected together, end to end, by one or more connecting elements 12, two of which are shown in FIGS. 2 and 3 and three of which are shown in FIGS. 4a-4c. The connecting elements 12 are spaced apart and the outer connecting elements 12a and 12c are preferably located proximate adjacent corners of the tag.

Connecting elements 12 space adjacent tags 10 a short distance from each other such that adjacent tags are connected only by connecting 12 elements. Each hangtag 10 has pre-punched opening 16 defined in part by portion 18 of the tag body, situated between opening 16 and the end of the tag.

The opening 16 has a dual purpose. It serves to receive the plastic fastener 27 that will be used to attach the tag 10 to an article generally designated A. It also functions as a sprocket hole. The sprocket hole cooperates with sprockets on a feed wheel, which forms a part of the mechanism that feeds tags to the fastener attacher, as described below.

Elements 12 are designed such that the force needed to simultaneously sever all of the connecting elements is less than the force necessary to tear portion 18 of the tag body. Thus, once a fastener 27 has been inserted into opening 16 and through the article A to be tagged, as illustrated in FIG. 15, the operator causes the attached tag to separate from the next tag by simply pulling the article away from the apparatus in direction generally perpendicular to the end of the tag. This is possible because the product-tag connection is much stronger than the tag-to-tag connection.

For some applications, in order to separate the hangtags by pulling the attached hangtag away from the next hangtag in sequence, it is necessary to securely hold the next hangtag, as the attached article is pulled. This holding action can be provided for by a reciprocating member present in the automatic tag attaching apparatus or by the internal mechanism of a conventional thermal printer. For other applications, no holding action is required because the reciprocating mechanism severs some or all of the connecting elements reducing or eliminating the pull force necessary to separate the hangtags, prior to pulling the attached article.

FIG. 5 schematically illustrates the automatic tag attaching apparatus of the present with a first performed embodiment of the reciprocating member, which includes a combination tag clamping and connecting element severing mechanism. The apparatus includes a conventional plastic fastener dispensing device, generally designated B, with a housing 20 which may be a manually operated attacher, such as that disclosed in U.S. Pat. No. 4,416,407, issued Nov. 22, 1983 to Bone, U.S. Pat. No. 3,888,402, issued Jun. 10, 1975 to Bone, U.S. Pat. No. 3,924,788, issued Dec. 9, 1975 to Furutu or U.S. Pat. No. 4,288,017 issued Sep. 8, 1981 to Russell, or any other comparable device.

Fastener dispensing device B is adapted to dispense plastic fasteners 27 (see FIG. 15) capable of attaching tags 10 to articles A. Fastener 27 has a thin, stretched (and hence high strength) plastic filament 29 with a T-bar 31 at one end and an enlarged paddle or button 33 at the other end.

Housing 20 has a hollow slotted metal needle 22 protruding from its front. As seen in FIG. 6, connected fasteners 27, supplied on a roll 35, are fed to the housing 20 and the T-bars 31 are ejected, one at a time, through needle 22, as the device is actuated by depressing the trigger.

By appropriately positioning the hangtag 10 and article A one on top of the other, the needle can be received through tag opening 16 and penetrate the article A to be tagged. After fastener 27 is ejected from needle 22, the T-bar 31 of the dispensed fastener is situated on one side of the hangtag/article assembly and the paddle 33 remains on the other side, see FIG. 7. In this way, tag 10 is attached to the article A by fastener 27 and cannot be removed without tearing the tag or cutting the filament, preventing tag switching in the store.

Housing 20 is mounted above a work surface 32 by a support 41. Attacher housing 20 is mounted for movement relative to work surface 32 by a double acting pneumatic cylinder 43, such as disclosed in U.S. Pat. No. 4,718,158, issued Jan. 12, 1988 to Block. Cylinder 43 is actuated to advance housing 20 toward work surface 32, where the hangtag 10 to be attached is situated. Article A to be tagged is situated below surface 32. The needle 22 passes through opening 16 in the tag, a slit 45 in surface 32 which is present to accommodate the needle, and penetrates article A. The fastener 27 is then automatically ejected through needle 22 by depression of trigger of device B. After the fastener is ejected, cylinder 43 actuated to move the housing 20 away from the work surface 32, leaving the fastener 27 connecting tag 10 to article A.

The fastener dispensing device trigger can be actuated by another pneumatic cylinder (not shown), which depresses the trigger at the appropriate time, as in the Block patent, or by a stationary member against which the trigger abuts as housing 20 is advanced toward the work surface or by any other means. However, regardless of the action of the fastener dispenser, conventional tag attaching devices which are automatic, in the sense that they automatically position the tag, but which do not include cutters, all feed tags from a stack of separate tags. The tags cannot be supplied on a supply roll or be connected to each other, unless some cutting mechanism is employed. This is because, if the tags were connected end to end, the operator would have to hold the tag next to the one attached to the article and tear the tag attached to the article off the next tag (as described above) to remove the article, a cumbersome and time consuming activity.

My invention eliminates this problem through the use of the above described tag connecting structure, which may be used in conjunction with a reciprocating member which forms a part of the tag feed apparatus or with a thermal printer that prints tags upon demand, as described below. As seen in FIG. 5, pre-printed hangtags 10, connected end-to-end by the connecting elements 12 described above, are supplied on a continuous supply roll 24. The strip of tags 10 is removed from roll 24 by rotation of a sprocket wheel 26 which has a plurality of spaced, outwardly extending sprockets 28 around its circumference. The motor which drives wheel 28 is not shown in the drawings. Sprockets 28 engage openings 16 in the hangtags so as to move the hangtags along a curved guide 47 from roll 24 on to work surface 32.

Sprockets 28 and openings 16 may be round as is conventional. However, for some applications, such as when only a single connecting element 12 is utilized between the hangtags or some of the connecting elements are severed by the reciprocating member, both the sprocket 28 and openings 16 may be non-circular, preferably oval, such that the tags cannot rotate relative to each other.

The strip of connected hangtags 10 travels from sprocket wheel 26, along work surface 32, until the gap between the lead hangtag and the next hangtag in sequence aligns with an elongated opening 34 in a work surface 32. The reciprocating member, generally designated C, is located above opening 34.

Reciprocating member C can take any one of three different forms, depending upon whether tag holding, connecting element severing, or both, are required. FIGS. 5 through 10 illustrate the first preferred embodiment of the reciprocating member, which automatically performs both the tag holding and connecting element severing functions.

In its first preferred embodiment, reciprocating member C includes a clamping plate 50 suspended from a support member 52 by first and second rods 54. Rods 54 are surrounded by springs 56 which normally urge plate 50 away from member 52. The bottoms of rods 54 are fixed to plate 50 but extend through openings in member 52 such that plate 50′ and member 52 normally move together but member 52 can move relative to plate 50, against the urging of springs 56, as explained below.

Plate 50 is mounted to the bottom of cylinder rod 58 which extends from a double acting pneumatic cylinder 60 which is fixed to the apparatus frame: A pair of guide rods 62, which extend through openings in a bracket 64, also fixed to the apparatus frame, insure that member 52 remains parallel to bracket 64 as member 52 is moved relative to bracket 64 by cylinder 60.

Member 52 carries downward extending severing rods 66. Rods 66 are provided with pointed or rounded ends, as required. Two rods 66 are disclosed for purposes of illustration. However, it should be understood that one or more rods 66 could be used, depending upon how many elements are to be severed. Rods 66 are positioned to align with two of the connecting elements 12a and 12c connecting the lead tag with the next tag in sequence and thus opening gap 34 in work surface 32. Plate 50 is provided with channels 51 aligned with rods 66, respectively. Channels 51 permit rods 66 to pass through plate 50.

Plate 50, as best seen in FIG. 5, has an undersurface with two surface sections 68, 70. The lower section 68 aligns with the next tag in sequence situated on the portion of work surface 32 behind (to the right as seen in the drawings) opening 34. The higher surface section 70 aligns with the lead hangtag 10 situated on work surface 32 in front of opening 34. When plate 50 is moved downwardly, only the next tag in sequence is clamped to work surface 32 by surface 68. Because section 70 is spaced from work surface 32 distance at least as great at the thickness of the hangtag, the lead tag is not clamped to work surface 32 by plate 50, permitting the lead tag to be removed from the apparatus after it is attached to the article by the fastener.

The operation of the first embodiment of the reciprocating member C is best understood with reference to FIG. 5 through 10. In the initial position, as depicted in FIG. 8, cylinder rod 58 is retracted and a lead hangtag 10 is situated on work surface 32 with slit 45 aligned with needle 22, as shown in FIG. 5.

Cylinder 60 is actuated to extend rod 58, causing member 52 to move downward such that surface 68 of plate 50 clamps the next second tag in sequence securely to work surface 32, as seen in FIGS. 7 and 9. In this position, the downward movement of member 52 could be stopped, the attacher housing moved down such that the needle 22 extends through opening 16 in the lead tag, penetrates article A to be tagged, the fastener ejected and housing 20 returned to its initial position. The article could be removed from the apparatus, bringing the attached tag with it, as the connecting element 12 are severed by the pull force on the hangtag transmitted through the fastener, in a direction generally perpendicular to the tag end. As mentioned earlier, portion 18 of the tag body between opening 16 and the end of the tag, is stronger than the force necessary to sever all of the connecting elements 12 simultaneously. After the attached tag is removed, the reciprocating member could be retracted, releasing the clamping force, and the next tag be advanced along work surface 32.

However, if a plurality of connecting element 12 are employed, such as illustrated in FIG. 4a, the first embodiment of the reciprocating member can also be used to automatically sever some or all of the connecting elements 12 prior to removal of the attached article. This is accomplished by continuing the downward movement of the plate 50, as described below.

FIGS. 4a-4c show adjacent tags 10 connected by three spaced connecting elements 12a, 12b and 12c. Referring again to FIGS. 9 and 10, from the intermediate position of member 52 shown in FIG. 9, further actuation of cylinder 60 causes rod 58 to extend to a greater extent, causing member 52 to move towards plate 50 (which at the point is stationary because surface 68 is on the hangtag on work surface 32, compressing springs 54 and causing rods 66 to extend through openings 51 in member 52, (see FIG. 10). This causes the severing of connecting elements 12a and 12c; while leaving element 12b in tact, as shown in FIG. 4b.

At this point, housing 20 is advanced, the fastener is ejected and the housing returns to the initial position. The second tag remains clamped between surface 68 of plate 50 and work surface 32. The article with the attached hangtag is removed from the apparatus, applying a pull force on the attached hangtag through the fastener, severing the remaining intact connecting element 12b, as seen in FIG. 4c. The reciprocating member C returns to its initial position, releasing the next hangtag. Sprocket wheel 26 is then rotated, advancing the next hangtag into alignment with the attaching device B.

The second preferred embodiment of the reciprocating member C′ is illustrated in FIGS. 11 and 12. This embodiment performs only the severing operation. Sometimes, clamping is not needed because after the automatic severing operation, the pull force necessary to manually sever the remaining connecting element by removing the attached article is substantially less than is necessary to rotate the sprocket wheel. Thus, after automatically severing connecting elements 12a and 12c, the clamping force inherent in the hangtag feed mechanism itself is sufficient to hold the next hangtag.

As seen in FIG. 11, cylinder 60 is connected to member 52 by rod 58, guide rods 62 maintain member 52 is a plane parallel to bracket 64, which is affixed to the apparatus frame, as in the previous embodiment. As cylinder 60 is actuated, rod 68 causes member 52 to move toward surface 32 such that rods 66 automatically sever connecting elements 12a and 12c, leaving connecting element 12b intact. Cylinder 60 then reverses, retracting rod 58, member 52 moves away from the work surface and the tagged article is removed, manually severing remaining connecting element 12b, as shown in FIG. 4c.

The third preferred embodiment of the reciprocating member C” is shown in FIGS. 13 and 14. In this case, only clamping is performed. All of the connecting elements are severed manually.

As shown in FIG. 13, plate 50 is connected directly to cylinder rod 68 such that actuation of cylinder 60 causes plate 50 to move downwardly and clamp the second tag between surface 68 and work surface 32, as shown in FIG. 14. The tag attaching device B is actuated, ejecting the fastener and the tagged article is removed, pulling the attached tag and manually severing the connecting elements. The cylinder rod 68 retracts, unclamping the next tag, and the sprocket wheel advances to feed the next tag into alignment with housing 20.

Cylinder 42 is actuated by a switch 72 located under work surface 32 to advance device B toward the aligned tag such that the needle 22 passes through opening 16 in the tag and penetrates the article. As device B is advanced, the trigger of the attacher is depressed to eject the fastener. Device B is then moved back to its original position, with-drawing needle 22 from the article A and tag 10, leaving the fastener 27 in place. Switch 72 is actuated by part 74 carried on a plate 76 pivotally mounted to the apparatus frame below work surface 32. Plate 76 is pivoted to actuated switch 76 by insertion of article A.

The operator simply removes the tagged article from the apparatus, applying a pull force through the fastener in a direction generally perpendicular to the tag end. This motion simultaneously severs the connecting elements 12 between the tag 10 attached to the article A and the next tag in sequence. After the article is removed, sprocket wheel 26 is indexed to bring the next tag into alignment with needle 22 and the cycle is repeated.

In situations where the product to be tagged is not rigid enough to pivot plate 76, for example, a sheet of garment material, a different activation device may be used. That activation device could be a foot pedal located under the work surface.

FIG. 16 illustrates the use of the hangtags of the present invention, in non-preprinted form, in a thermal transfer printer, generally designated D, for example a SPX-320 printing system available from Soabar Products Group, 7772 Dungan Road, Philadelphia, Pa. 19111. This unit is computer controlled and prints tags in accordance with instructions received from a keyboard, not shown. Printer D permits the operator to print tags as required, instead of using preprinted tags.

When this type of printer is employed, a supply roll 80 of blank hangtags of the type shown in FIGS. 2, 3 is inserted into the machine. The strip of hangtags 10 is fed from roll 80 between the print head 82 and roller 83 of the thermal transfer printer. By using hangtags of the present invention the necessity for an automatic cutter is eliminated. The internal mechanism of the printer itself holds the next tag, as the printed tag is removed. No external means for clamping the next hangtag in sequence is required. After printing, the hangtags are simply pulled from the printer.

However, the printer can be used in combination with an automatic tagging device. As shown in FIG. 17, after tags 10 are printed one at a time by head 82, they are fed onto work surface 32, into alignment with housing 20. The automatic attacher device B is actuated to advance toward the tag/article assembly as previously described and after the needle 22 is inserted through the tag opening and the article A to be tagged, the fastener 27 is dispensed and the needle 22 withdrawn, the tagged article is removed from the apparatus, causing the tag attached to the article to separate from the next tag, which is retained by the internal mechanism of the printer. The next tag is then printed and the cycle repeats. A reciprocating member C′, as illustrated in FIGS. 11 and 12, could be used in combination with printer D, if severing of some of the connecting elements is desired.

A printer of this type, using conventional hangtags, would require an expensive automatic cutter to cut and stack the printed tags. The stack of tags would have to be transferred to the automatic attacher stack hopper. The position of the hopper relative to the fastener dispenser would have to be set precisely such that the needle would correctly align with the hangtag opening. Utilizing the hangtags of the present invention, the necessity for an expensive cutter is entirely eliminated, as is the need for precise positioning of the hopper. However, the connecting elements are constructed in such a way that the resulting end of the hangtag is straight and clean, similar to that which would be obtained by a knife or cutter blade.

It will now be appreciated that the present invention relates to hangtags of novel connecting structure designed for use in an automatic tag attacher, which may include a conventional tag printer. Because the adjacent hangtags are connected so they can be easily separated as one tag is pulled away from the next, the hangtags are uniquely adapted for use in an automatic tag attacher including a reciprocating member providing holding and/or severing operations, in accordance with the present invention. The hangtags are also suited for use with a thermal transfer printer, alone or in combination with an automatic tagging device.

While only a limited number of preferred embodiments of the present invention have been disclosed for purposes of illustration, it is obvious the many variations and modifications could be made thereto. It is intended to cover all of these variations and modifications which fall within the scope of the present invention, as defined by the following claims:

1. Hangtags adapted to be supplied in a continuous roll of end-to-end connected hangtags comprising means for connecting adjacent hangtags, said connecting means comprising one or more connecting elements extending between the ends of adjacent hangtags and spacing said hangtag ends a short distance apart, said connecting elements being severable to separate said adjacent hangtags by the application of a pull force in a direction substantially perpendicular to the ends of the hangtags.

2. The hangtags of claim 1 wherein said connecting means comprises two or more spaced connecting elements and wherein said pull force is applied to sever said connecting elements substantially simultaneously.

3. The hangtags of claim 1 having a body with an opening adapted to receive a fastener, said opening being defined by a portion of said body and wherein the force required to tear said body portion is greater than said pull force necessary to sever said connecting elements.

4. The hangtags of claim 3 wherein said pull force is applied through the fastener anchored within said body opening.

5. The hangtags of claim 1 for use in combination with means for holding one hangtag as the adjacent hangtag is separated from it by severing said connecting means.

6. The combination of claim 5 further comprising a work surface, wherein said holding means comprises a plate and means for moving said plate relative of said work surface to hold said one hangtag therebetween.

7. The combination of claim 5 or use in combination with means for severing at least one of said connecting elements prior to application of said pull force.

8. The hangtags of claim 1 for use in combination with means for severing at least one of said connecting elements prior to the application of said pull force.

9. The hangtags of claim 1 for use in combination with means for feeding hangtags, one at a time, to a means for attaching a fastener, said fastener attaching means comprising a hollow needle, means for inserting said needle through said hangtag and means for ejecting a fastener through said needle.

10. The combination of claim 9, wherein said hangtag has an opening and said hangtag feeding means comprises a wheel with a plurality of sprockets of substantially the same size and shape as said hangtag opening.

11. The combination of claim 10, wherein said hangtag opening functions as a sprocket hole and as a fastener receiving hole.

12. The hangtags of claim 1 for use in combination with thermal transfer means for imprinting said hangtags.

13. The combination of claim 12 further comprising means for attaching said printed hangtags to an article.

14. The combination of claim 13, wherein said attaching means comprises a hollow needle, means for inserting said needle through said hangtag and means for ejecting a fastener through said needle.

15. The hangtags of claim 3 wherein said opening is non-circular.

16. The hangtags of claim 1 wherein said body is generally rectangular with rounded corners.

17. Hangtags adapted to be supplied in a continuous roll of end-to-end connected hangtags comprising means for connecting adjacent hangtags, said connecting means comprising one or more connecting elements extending between the ends of adjacent hangtags and spacing said hangtag ends a short distance apart, said connecting elements being severable to separate said adjacent hangtags, said hangtags having a body with an opening adapted to receive a fastener, said opening being defined by a portion of said body and wherein the force required to tear said body portion is greater than the force necessary to sever said connecting elements.

18. The hangtags of claim 17 wherein said connecting means comprises two or more spaced connecting elements and wherein said pull force is applied to sever said connecting elements substantially simultaneously.

19. The hangtag of claim 17 wherein said pull force is applied in a direction substantially perpendicular to the end of said hangtag.

20. The hangtags of claim 17 for use in combination with means for holding one hangtag as the adjacent hangtag is separated from it by severing said connecting means.

21. The hangtags of claim 17 for use in combination with means for feeding hangtags from said roll.

22. The combination of claim 21 further comprising means for holding one hangtag while the adjacent hangtag is severed.

23. The combination of claim 21 further comprising means for severing at least one of said connecting elements prior to the application of said force to sever said connecting elements.

24. The combination of claim 22 further comprising means for severing at least one of said connecting elements prior to the application of said force to sever said connecting elements.

25. The combination of claim 22 further comprising a work surface, wherein said holding means comprises a plate and means for moving said plate relative to said work surface to hold said one hangtag therebetween.

26. The hangtags of claim 21 for use in combination with means for severing at least one of said connecting elements prior to the application of said pull force.

27. The hangtags of claim 21 for use in combination with means for severing at least one of said connecting elements prior to application of said pull force and means for holding one hangtag as the adjacent hangtag is separated from it.
